(19) United States
(12) Patent Application Publication
(10) Pub. No.: US 2026/0168590 A1
(43) Pub. Date: Jun. 18, 2026

(54) PROPORTIONAL VALVE

(71) Applicant: YINGJIA POWER TECHNOLOGY WUXI COMPANY., LTD, Jiangsu (CN)

(72) Inventors: Jianming ZHANG, Jiangsu (CN); Guangcun JI, Jiangsu (CN); Yihan WEI, Jiangsu (CN); Xiaolan ZHAO, Jiangsu (CN); Yaowei SUN, Jiangsu (CN); Youjie GU, Jiangsu (CN); Qi FENG, Jiangsu (CN); Qiufeng FANG, Jiangsu (CN)

(73) Assignee: YINGJIA POWER TECHNOLOGY WUXI COMPANY., LTD, Jiangsu (CN)

(21) Appl. No.: 19/533,295

(22) Filed: Feb. 9, 2026

Related U.S. Application Data
(63) Continuation of application No. PCT/CN2023/111998, filed on Aug. 9, 2023.

(51) Int. Cl. F16K 31/06; F16K 27/02

(52) U.S. Cl. CPC F16K 31/0655; F16K 27/029

(57) ABSTRACT

A proportional valve includes a welded component and a tightening cap connected to the welded component, which includes a magnetic isolation sleeve and a base connected to the magnetic isolation sleeve, and a valve body is installed inside the base; an adjustment screw threadedly connected to the tightening cap; an armature assembly including a shaft, a spring, an armature seat, and an armature. The armature seat is pressed into an accommodating hole of the armature and tightly presses the spring between the armature seat and the armature, a valve body gasket is installed between the spring and the valve body, a lift adjustment gasket is installed between the spring and the base, a guide mechanism is installed inside the tightening cap, and an upper end of the shaft is located in a hollow structure of the guide mechanism; and a coil assembly sleeved on outside of the magnetic isolation sleeve.

### CROSS-REFERENCE TO RELATED APPLICATION

This application is a continuation of International Application of PCT application serial no. PCT/CN2023/111998 filed on Aug. 9, 2023. The entirety of the above-mentioned patent application is hereby incorporated by reference herein and made a part of this specification.

### BACKGROUND

### Technical Field

The present invention relates to the technical field of solenoid valves and, more specifically, to a proportional valve.

### Description of Related Art

A proportional valve is a component in which an electromagnet module inside the valve generates a corresponding action according to an input current signal, causing a working valve spool to displace, changing a valve port size, and thereby completing pressure and flow output proportional to the input current. For example, a Chinese invention patent with application number 201880054472.1 disclosed a proportional valve for controlling a gaseous medium, in which a closing element arranged in a valve housing cooperates with a valve seat so as to open and close at least one through opening. In addition, there are a magnetic armature device and an electromagnet operatively connected to the closing element, where the electromagnet generates a magnetic force acting on the magnetic armature device, and the magnetic armature device can move up and down along a longitudinal axis of the proportional valve. The electromagnet includes an inner pole, an outer pole, and an electromagnetic coil, and the magnetic armature device includes a magnetic armature. The valve housing and the inner pole are magnetically connected to each other via a magnetic throttle portion, and the magnetic throttle portion is constructed in an axial extension region of the magnetic armature. Furthermore, the inner pole has a groove, the groove having a groove edge, and the magnetic armature sinks into the groove during its lifting movement. In a closed state of the proportional valve, an end face of the magnetic armature is at the same height, relative to the longitudinal axis, as the groove edge of the groove. The groove edge constitutes an end of the magnetic throttle portion. In the invention, electronically controlling a flow cross-section of the through opening can significantly more accurately supply a first gaseous medium and dose hydrogen into an anode region of a fuel battery while regulating anode pressure, thereby improving operational safety and durability of the connected fuel battery. However, in the invention, the absence of a modular design makes disassembly and assembly of the proportional valve inconvenient, and it is also inconvenient to adjust a lift size according to actual needs. The magnetic armature device in the invention is guided by a first guide section and a second guide section during lifting movement, and the magnetic armature device generates friction with both the first guide section and the second guide section, resulting in large frictional resistance and poor hysteresis performance and repeatability performance of the proportional valve.

### SUMMARY

The present invention provides a proportional valve to achieve convenient disassembly and assembly of the proportional valve and improve hysteresis performance and repeatability performance of the proportional valve.

To solve the above technical problems, the technical solution of the present invention is as follows:

A proportional valve, including:
a welded body component including a welded component and a tightening cap connected to the welded component. Specifically, the welded component and the tightening cap are connected by welding.

The welded component includes a magnetic isolation sleeve and a base connected to the magnetic isolation sleeve, and a valve body is disposed at a lower part of the base. Specifically, a first stepped hole is provided inside the base, the valve body is installed inside the first stepped hole, and the base and the magnetic isolation sleeve are connected by welding. A material of the base is magnetically conductive stainless steel. An external thread is provided on an outer part on a lower side of the base for connecting a mounting hole. An internal thread is provided at a lower part of the first stepped hole, and a bottom of the step is flat. An outer diameter of a lower part of the tightening cap is the same as that of the magnetic isolation sleeve. An external thread is provided at an upper part of the tightening cap. A relief groove is provided on a side wall of the tightening cap below the external thread. A through hole is provided inside the tightening cap. An internal thread is provided at an upper part of the through hole. A sealing ring introduction angle is provided between a middle part of the through hole and the relief groove. A diameter of a bottom of the through hole is larger than that of the middle part.

The proportional valve further includes an armature assembly, including a spring piece, an armature seat, and an armature mechanism, where the armature seat is installed at a bottom of the armature mechanism and tightly presses the spring piece between the armature mechanism and the armature seat, an armature spring is sleeved on an outer side of an upper part of the armature mechanism, a guide mechanism for guiding a moving direction of the armature mechanism is installed inside the tightening cap, a bottom of the guide mechanism is configured as a hollow structure, and an upper part of the armature mechanism is located in the hollow structure at the bottom of the guide mechanism.

Specifically, the armature mechanism includes a shaft and an armature, that is, the armature assembly includes the shaft, the spring piece, the armature seat, and the armature. An accommodating hole is provided at a bottom of the armature. An upper end of the armature seat is installed in the accommodating hole and tightly presses the spring piece between the armature seat and the armature. A valve body gasket is installed between the spring piece and the valve body to thereby tightly press the spring piece. The spring piece, after being pressed tightly, is bowl-shaped with periphery upward and center downward. A lift adjustment gasket is installed between the spring piece and an inner top wall of the base. Specifically, the lift adjustment gasket and the valve body gasket are both annular structures. Outer diameters of the lift adjustment gasket and the valve body gasket match a thread bottom hole diameter at a lower part of the base. Inner diameters of the lift adjustment gasket and the valve body gasket are larger than an inner diameter of an outer annular portion of the spring piece. The thickness of the lift adjustment gasket can be selected from various specifications. With the use of lift adjustment gaskets of different thicknesses, a distance between a boss of the armature and a magnetic isolation gasket installed on an inner side of a bottom of the tightening cap can be adjusted.

A second stepped hole is provided at a top of the armature. A lower end of the shaft is located in the second stepped hole. The armature spring is sleeved on an outer side of the shaft. A guide mechanism for guiding a moving direction of the shaft is installed inside the tightening cap. A bottom of the guide mechanism is configured as a hollow structure. An upper end of the shaft is located in the hollow structure at the bottom of the guide mechanism. The armature spring is a cylindrical helical spring made of non-magnetically conductive stainless steel, and its inner diameter is larger than an outer diameter of the shaft. The guide mechanism tightly presses the armature spring from above. Screwing in or out the guide mechanism can adjust a spring force of the armature spring.

The proportional valve further includes a coil assembly sleeved on an outer side of the magnetic isolation sleeve, where a material of the magnetic isolation sleeve is non-magnetically conductive stainless steel in a shape of a sleeve with uniform wall thickness, and an inner hole of the magnetic isolation sleeve has the same diameter as a through hole of the base.

Further, the guide mechanism is an adjustment screw assembly, and the adjustment screw assembly including an adjustment screw. A through hole is provided inside the tightening cap. The adjustment screw is threadedly connected to an inner wall of the tightening cap. A bottom of the adjustment screw is a hollow structure.

Further, a boss is provided at a top of the base. A bottom of the coil assembly is in contact with the boss. The boss is used for installation and positioning of the coil assembly. A hex thin nut is threadedly connected to an outer side wall of the tightening cap above the coil assembly. In other words, the coil assembly is installed on the boss of the base, and an upper top part thereof is tightly pressed by the hex thin nut cooperated with an external thread of the tightening cap.

Further, a vent hole communicating with the hollow structure at the bottom of the adjustment screw is provided in a side wall of the adjustment screw.

Further, an upper end of the armature spring is in contact with a lower end of the adjustment screw. A spring guide hole is formed between an inner wall at an upper end of the second stepped hole and an outer wall of the shaft. A lower end of the armature spring is disposed in the spring guide hole.

Further, a flat slot or other mechanism for driving rotation is provided at a top of the adjustment screw. A first sealing ring groove is provided in a middle outer side wall of the adjustment screw. A first sealing ring is installed in the first sealing ring groove. The first sealing ring is an O-type rubber sealing ring for separating an interior of the proportional valve from an exterior.

Further, a second sealing ring groove is provided in a side wall of the valve body. A second sealing ring and a blocking ring are installed in the second sealing ring groove.

Further, an external thread is provided on a side wall of a lower end of the base. An upper end of the base is a hexagonal mounting flange. A third sealing ring groove is provided in a side wall of the base above the external thread. Precisely, the third sealing ring groove is located between the external thread and the mounting flange. A hole diameter at a top of the base is the same as a hole diameter of the magnetic isolation sleeve. A third sealing ring is installed in the third sealing ring groove.

Further, a flange is provided on an outer side of an upper part of the valve body. The flange is provided with an external thread. The external thread of the flange matches an internal thread at a lower end of the first stepped hole inside the base. At least one air outlet hole axially runs through the flange. An air inlet hole axially runs through a middle of the valve body.

Further, the first stepped hole includes a first through hole located outwardly and a second through hole close to an inner cavity, where a diameter of the second through hole is smaller than a diameter of the first through hole. A magnetic isolation groove is provided in a side wall of the armature at a position near a lower part of the second through hole. In other words, the armature has the magnetic isolation groove at a position aligned with a bottom of the stepped hole of the base. The magnetic isolation groove is used to reduce a magnetic flux circulation area during an upward movement of the armature, thereby reducing a rising speed of electromagnetic force experienced by the armature during the upward movement.

Preferably, the first stepped hole includes a first through hole located outwardly and a second through hole close to an inner cavity, where a diameter of the second through hole is smaller than a diameter of the first through hole. An outer diameter of the armature is smaller than an inner diameter of the magnetic isolation sleeve. The outer diameter of the armature is smaller than a diameter of the second through hole. In other words, the outer diameter of the armature is smaller than inner diameters of the magnetic isolation sleeve and the base at corresponding positions, with a certain gap left.

Preferably, a bearing installation groove is provided in an inner wall at the bottom of the adjustment screw. A bearing is installed in the bearing installation groove. An upper end of the shaft is installed inside the bearing. A lower end of the shaft is press-fitted into the second stepped hole at the top of the armature. The shaft penetrates into the bearing. After assembly of the adjustment screw assembly is completed, a distance from the shaft to a bottom of a hole of the adjustment screw should be greater than a distance between a boss of the armature and a magnetic isolation gasket installed at a bottom of the tightening cap.

An upper part of the armature assembly is guided by the bearing, and a lower part is guided by the spring piece, avoiding contact with the magnetic isolation sleeve and the base, reducing friction, and improving hysteresis performance and repeatability performance of the proportional valve.

Preferably, a bearing is installed in the second stepped hole at the top of the armature. A lower end of the shaft is installed inside the bearing. An upper end of the shaft is press-fitted into the hollow structure at the bottom of the adjustment screw.

Preferably, a side wall at the bottom of the tightening cap is a boss structure. A groove for allowing the side wall at the bottom of the tightening cap to enter and exit is provided on an outer side of the top of the armature. The boss structure is used to increase initial electromagnetic force.

Preferably, a side wall of the top of the armature is a boss structure. A groove for allowing the side wall of the top of the armature to enter and exit is provided on an outer side of the bottom of the tightening cap.

Preferably, a groove body is provided on an inner side of the bottom of the tightening cap. A magnetic isolation gasket is installed in the groove body. The magnetic isolation gasket is an annular structure made of a non-magnetically conductive material. Its outer diameter matches an installation groove of the tightening cap. An inner hole diameter is larger than an outer diameter of the armature spring. The top of the armature is a boss structure adapted to the groove body at the bottom of the tightening cap for allowing the boss structure at the top of the armature to enter and exit the groove body at the bottom of the tightening cap. A diameter of the boss structure at the top of the armature is smaller than an outer diameter of the armature and smaller than an inner diameter of a bottom of the through hole of the tightening cap.

Since electromagnetic force experienced by the armature increases faster as the armature and the tightening cap approach each other, the magnetic isolation gasket can prevent mismatch between electromagnetic force and spring force caused by the distance between the armature and the tightening cap being too close.

Preferably, a groove body is provided on an inner side of the bottom of the tightening cap. The top of the armature is a boss structure adapted to the groove body at the bottom of the tightening cap. A magnetic isolation buffer gasket is installed on the boss structure at the top of the armature.

Preferably, a sealing gasket installation groove is provided at a bottom of the armature seat. A sealing gasket is installed in the sealing gasket installation groove. A stepped hole serving as an air inlet hole axially runs through a middle of the valve body. A hollow conical boss is provided at a top of the valve body. A diameter of the stepped hole on a side near the conical boss is smaller than a diameter of a top of the conical boss. A cone angle of the conical boss is 90°-120°. A hollow part of the conical boss communicates with the air inlet hole. The sealing gasket is located above the hollow part of the conical boss. A width of an annular band formed by the top of the conical boss and a hole inside the conical boss is 0.2-0.5 mm. During use, the sealing gasket contacts the conical boss at the top of the valve body to form a sealing surface.

Further, an exhaust hole enabling communication between the accommodating hole at the bottom of the armature and the sealing gasket installation groove is provided at a top of the armature seat. A vent hole enabling communication between the first stepped hole inside the base and the sealing gasket installation groove is provided in the armature seat. The exhaust hole is used to allow gas inside to be discharged when the armature seat is pressed into the armature. The vent hole is used to allow gas inside to be discharged when the sealing gasket is pressed into the armature seat.

Preferably, an installation groove is provided at a top of the valve body. A hollow gasket is installed in the installation groove. A protrusion structure adapted to a hollow part of the gasket is provided at a bottom of the armature seat.

Further, the spring piece includes a first ring and a second ring. A diameter of the first ring is smaller than a diameter of the second ring. The first ring and the second ring are connected together by at least three reciprocating bending structures. Each of at least three reciprocating bending structures includes a bent section. A width of the bent section is greater than a width of another part of the reciprocating bending structure.

Compared with the prior art, the technical solution of the present invention has the following beneficial effects:
First, the proportional valve provided by the present invention adopts a modular design. A user provides a mounting hole in a mounting body, and then the proportional valve can be installed through the external thread of the base, facilitating design of the customer's mounting body and subsequent overall disassembly and replacement of the proportional valve. Moreover, the valve body of the proportional valve of the present invention is screwed in and out from the internal thread at a lower part of the stepped hole of the base. The coil assembly is also installed in a detachable manner. The adjustment screw assembly is screwed into a hole at an upper part of the tightening cap from above. The modular design makes disassembly and assembly of the proportional valve relatively convenient.
Second, the proportional valve provided by the present invention is provided with a lift adjustment gasket. The thickness of the lift adjustment gasket can be selected from various specifications. With the use of lift adjustment gaskets of different thicknesses, a distance between a boss of the armature and a magnetic isolation gasket installed on an inner side of a bottom of the tightening cap can be adjusted.
Third, the proportional valve provided by the present invention is provided with a magnetic isolation groove. The design of the magnetic isolation groove can reduce a magnetic flux circulation area during an upward movement of the armature, thereby reducing a rising speed of electromagnetic force experienced by the armature during the upward movement.
Fourth, in the proportional valve provided by the present invention, an upper part of the armature assembly is guided by a bearing, and a lower part is guided by a spring piece, avoiding contact with the magnetic isolation sleeve and the base, with only a small section of friction with the bearing, reducing friction, and improving hysteresis performance and repeatability performance of the proportional valve.
Fifth, the boss structure designed in the proportional valve provided by the present invention can increase initial electromagnetic force, making the proportional valve more sensitive.
Sixth, the magnetic isolation gasket provided in the proportional valve of the present invention can prevent mismatch between electromagnetic force and spring force caused by the distance between the armature and the tightening cap being too close.

### BRIEF DESCRIPTION OF THE DRAWINGS

To illustrate the embodiments of the present invention or technical solutions in the prior art more clearly, the drawings required for description of the embodiments or the prior art will be briefly introduced below. Obviously, the drawings described below are only some embodiments of the present invention. For those of ordinary skill in the art, other drawings can also be obtained based on these drawings without creative efforts.

FIG. 1 is a schematic structural diagram of a proportional valve according to an embodiment of the present invention.

FIG. 2 is a schematic structural diagram after removal of a valve body gasket based on FIG. 1 of the present invention.

FIG. 3 is a schematic structural diagram after change of a position of a boss structure based on FIG. 1 of the present invention.

FIG. 4 is a schematic structural diagram after change of an installation position of a magnetic isolation gasket based on FIG. 1 of the present invention.

FIG. 5 is a schematic structural diagram after change of an installation position of a sealing gasket based on FIG. 1 of the present invention.

FIG. 6 is a schematic structural diagram after change of an installation position of a bearing based on FIG. 1 of the present invention.

FIG. 7 is a schematic structural diagram of a spring piece according to an embodiment of the present invention.

FIG. 8 is a schematic structural diagram after removal of a lift adjustment gasket based on FIG. 1 of the present invention.

### DESCRIPTION OF THE EMBODIMENTS

To better understand the purpose, structure, and function of the present invention, the technical solution of the present invention is further described in detail below with reference to the drawings and specific preferred embodiments.

In the description of the present invention, it should be understood that terms indicating orientations or positional relationships such as “left side”, “right side”, “upper part”, or “lower part” are based on orientations or positional relationships shown in the drawings, only for convenience of describing the present invention and simplifying the description, rather than indicating or implying that referred means or element must have specific orientations, be constructed and operated in specific orientations. Terms such as “first” and “second” do not indicate importance of components and therefore cannot be understood as limitations to the present invention. Specific dimensions used in the embodiments are only for illustrating the technical solution and do not limit the protection scope of the present invention. For those skilled in the art, it is understandable that some well-known structures and their descriptions in the drawings may be omitted.

Unless otherwise explicitly specified and defined, terms such as “installing”, “disposing”, “connecting”, and “fixing” should be understood broadly. For example, they can be a fixed connection, a detachable connection, or an integral connection, they can be a mechanical connection or an electrical connection, they can be a direct connection or an indirect connection through an intermediate medium, or they can be internal communication of two elements or interaction between two elements. For those of ordinary skill in the art, specific meanings of the above terms in the present application can be understood according to specific situations.

### Embodiment 1

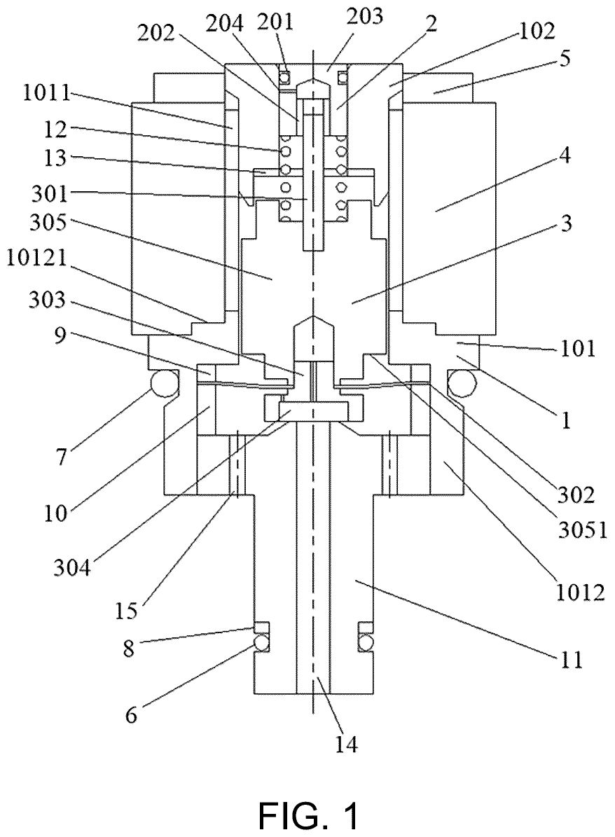

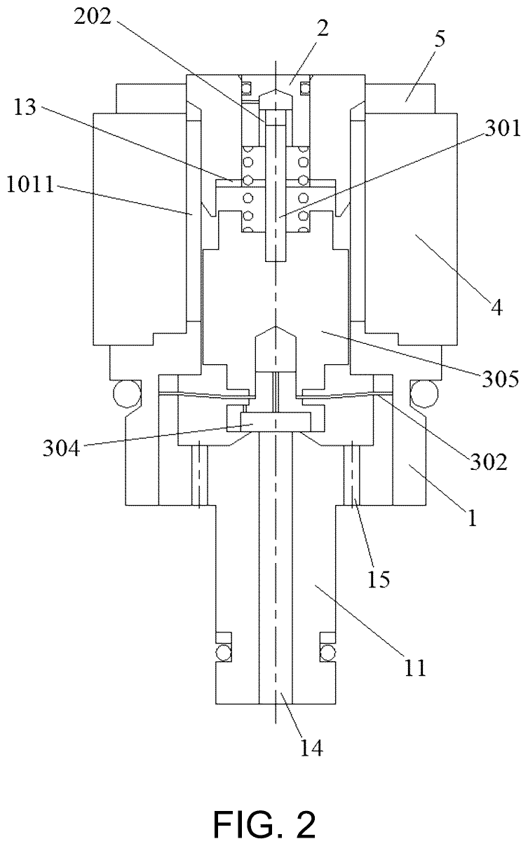

As shown in FIGS. 1 and 2, the present invention provides a technical solution: a proportional valve is provided, including:
a welded body component 1 including a welded component 101 and a tightening cap 102 connected to the welded component 101. Specifically, the welded component 101 and the tightening cap 102 are connected by argon arc welding.

The welded component 101 includes a magnetic isolation sleeve 1011 and a base 1012 connected to the magnetic isolation sleeve 1011. A valve body 11 is disposed at a lower part of the base 1012. Specifically, a first stepped hole is provided inside the base 1012. The valve body 11 is installed inside the first stepped hole. The base 1012 and the magnetic isolation sleeve 1011 are connected by friction welding. A material of the base 1012 is magnetically conductive stainless steel. An external thread is provided on an outer part on a lower side of the base 1012 for connecting a mounting hole. An internal thread is provided at a lower part of the first stepped hole, and a bottom of the step is flat. An outer diameter of a lower part of the tightening cap 102 is the same as that of the magnetic isolation sleeve 1011. An external thread is provided at an upper part of the tightening cap 102. A relief groove is provided on a side wall of the tightening cap 102 below the external thread. A through hole is provided inside the tightening cap 102. An internal thread is provided at an upper part of the through hole. A sealing ring introduction angle is provided between a middle part of the through hole and the relief groove. A diameter of a bottom of the through hole is larger than that of the middle part.

The proportional valve further includes an armature assembly 3, including a spring piece 302, an armature seat 303, and an armature mechanism, where the armature seat 303 is installed at a bottom of the armature mechanism and tightly presses the spring piece 302 between the armature mechanism and the armature seat 303. An armature spring 12 is sleeved on an outer side of an upper part of the armature mechanism, a guide mechanism for guiding a moving direction of the armature mechanism is installed inside the tightening cap 102, a bottom of the guide mechanism is configured as a hollow structure, and an upper part of the armature mechanism is located in the hollow structure at the bottom of the guide mechanism.

The armature mechanism includes a shaft 301 and an armature 305.

The armature mechanism may be a primary armature mechanism or a regenerated armature mechanism. The primary armature mechanism indicates integral formation of the shaft 301 and the armature 305 in the armature mechanism. The regenerated armature mechanism indicates separately manufacturing the shaft 301 and the armature 305 and then assembling them.

In other words, the armature assembly 3 includes the shaft 301, the spring piece 302, the armature seat 303, and the armature 305.

The armature seat 303 and the armature 305 have various connection methods. For example, an accommodating hole is provided at a bottom of the armature 305. An upper end of the armature seat 303 is installed in the accommodating hole and tightly presses the spring piece 302 between the armature seat 303 and the armature 305. The upper end of the armature seat 303 is press-fitted into the accommodating hole at the bottom of the armature 305. Certainly, the armature seat 303 and the armature 305 can also adopt other connection methods such as threads or glue, or by opening a hole in the armature seat 303.

When the armature mechanism is a regenerated armature mechanism, a second stepped hole is provided at a top of the armature 305. A lower end of the shaft 301 is located in the second stepped hole. The armature spring 12 is sleeved on an outer side of the shaft 301. A guide mechanism for guiding a moving direction of the shaft 301 is installed inside the tightening cap 102. A bottom of the guide mechanism is configured as a hollow structure. An upper end of the shaft 301 is located in the hollow structure at the bottom of the guide mechanism.

When the armature mechanism is a primary armature mechanism, the shaft 301 and the armature 305 are made as one part. The top of the armature 305 is flat and may not require the second stepped hole.

The armature spring 12 is a cylindrical helical spring made of non-magnetically conductive stainless steel, and its inner diameter is larger than an outer diameter of the shaft 301. The guide mechanism tightly presses the armature spring 12 from above. By means of adjusting screwing in or out of the guide mechanism, a spring force of the armature spring 12 can be adjusted.

The proportional valve further includes a coil assembly 4 sleeved on an outer side of the magnetic isolation sleeve 1011, where a material of the magnetic isolation sleeve 1011 is non-magnetically conductive stainless steel in a shape of a sleeve with uniform wall thickness, and an inner hole of the magnetic isolation sleeve 1011 has the same diameter as a through hole of the base 1012.

The proportional valve according to the present invention adopts a modular design, facilitating disassembly and assembly of the proportional valve.

In terms of disassembly and assembly of the proportional valve on a mounting body, a user provides a mounting hole in the mounting body, and then the proportional valve can be installed through the external thread of the base 1012, facilitating design of the customer's mounting body and subsequent overall disassembly and replacement of the proportional valve.

In terms of disassembly and assembly of internal parts of the proportional valve, the valve body 11 is screwed in and out from the internal thread at a lower part of the stepped hole of the base 1012, and the coil assembly 4 is also installed in a detachable manner.

### Embodiment 2

On the basis of Embodiment 1, referring to FIG. 1, the guide mechanism is an adjustment screw assembly 2 including an adjustment screw 203. A through hole is provided inside the tightening cap 102. The adjustment screw 203 is threadedly connected to an inner wall of the tightening cap 102. A bottom of the adjustment screw 203 is a hollow structure. Specifically, an upper part of the adjustment screw 203 is an external thread matching an internal thread of the tightening cap 102. An outer diameter of the adjustment screw 203 is smaller than a diameter of a middle part of the through hole of the tightening cap 102. The adjustment screw assembly 2 is screwed into a hole at an upper part of the tightening cap 102 from above.

Further, a vent hole 204 communicating with the hollow structure at the bottom of the adjustment screw 203 is provided in a side wall of the adjustment screw 203.

Further, an upper end of the armature spring 12 is in contact with a lower end of the adjustment screw 203. A spring guide hole is formed between an inner wall at an upper end of the second stepped hole and an outer wall of the shaft 301. A lower end of the armature spring 12 is disposed in the spring guide hole.

Further, a flat slot or other mechanism for driving rotation is provided at a top of the adjustment screw 203. A first sealing ring groove is provided in a middle outer side wall of the adjustment screw 203. A first sealing ring 201 is installed in the first sealing ring groove. The first sealing ring 201 is an O-type rubber sealing ring for separating an interior of the proportional valve from an exterior.

### Embodiment 3

On the basis of Embodiment 2, referring to FIG. 1, the first stepped hole includes a first through hole located outwardly and a second through hole close to an inner cavity, where a diameter of the second through hole is smaller than a diameter of the first through hole. An outer diameter of the armature 305 is smaller than an inner diameter of the magnetic isolation sleeve 1011. The outer diameter of the armature 305 is smaller than a diameter of the second through hole. In other words, the outer diameter of the armature 305 is smaller than inner diameters of the magnetic isolation sleeve 1011 and the base 1012 at corresponding positions, with a certain gap left.

### Embodiment 4

On the basis of Embodiment 2, referring to FIGS. 1 and 2, a bearing installation groove is provided in an inner wall at the bottom of the adjustment screw 203. A bearing 202 is installed in the bearing installation groove. An upper end of the shaft 301 is installed inside the bearing 202. A lower end of the shaft 301 is press-fitted into the second stepped hole at the top of the armature 305. The shaft 301 penetrates into the bearing 202. After assembly of the adjustment screw assembly 2 is completed, a distance from the shaft 301 to a bottom of a hole of the adjustment screw 203 should be greater than a distance between a boss of the armature 305 and a magnetic isolation gasket installed at a bottom of the tightening cap 102.

An upper part of the armature assembly 3 is guided by the bearing 202, and a lower part is guided by the spring piece 302, avoiding contact with the magnetic isolation sleeve 1011 and the base 1012, reducing friction, and improving hysteresis performance and repeatability performance of the proportional valve.

### Embodiment 5: (This Embodiment is a Variant Structure of Embodiment 4, Differing in an Installation Position of the Bearing)

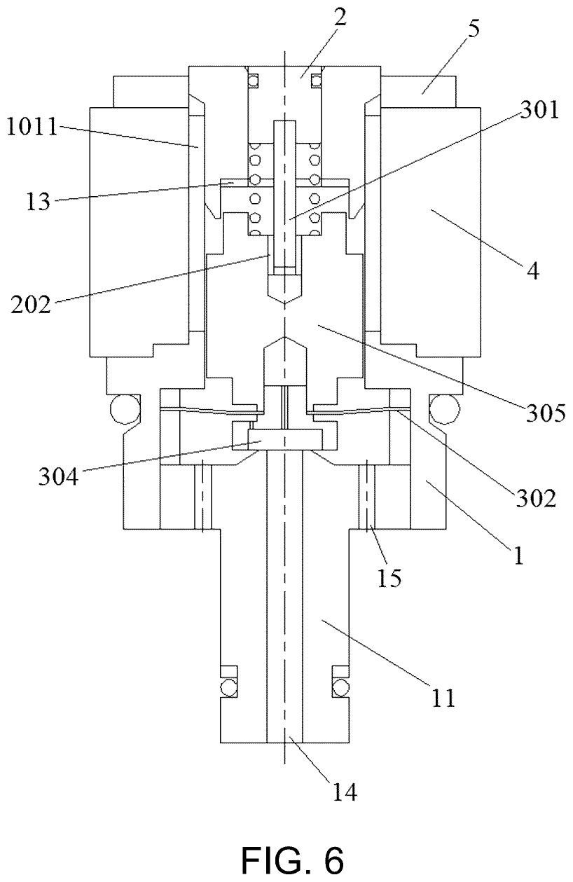

On the basis of Embodiment 2, referring to FIG. 6, a bearing is installed in the second stepped hole at the top of the armature 305. A lower end of the shaft 301 is installed inside the bearing. An upper end of the shaft 301 is press-fitted into the hollow structure at the bottom of the adjustment screw 203.

### Embodiment 6

On the basis of Embodiment 1, referring to FIG. 1, a boss 10121 is provided at a top of the base 1012. A bottom of the coil assembly 4 is in contact with the boss 10121. The boss 10121 is used for installation and positioning of the coil assembly 4. A hex thin nut 5 is threadedly connected to an outer side wall of the tightening cap 102 above the coil assembly 4. In other words, the coil assembly 4 is installed on the boss 10121 of the base 1012, and an upper part thereof is tightly pressed by the hex thin nut 5 cooperating with an external thread of the tightening cap 102.

Further, a second sealing ring groove is provided in a side wall of the valve body 11. A second sealing ring 6 and a blocking ring 8 are installed in the second sealing ring groove. The second sealing ring 6 and the blocking ring 8 serve to separate the air inlet hole 14 and the air outlet hole 15.

Further, an external thread is provided on a side wall of a lower end of the base 1012. An upper end of the base 1012 is a hexagonal mounting flange. A third sealing ring groove is provided in a side wall of the base 1012 above the external thread. Precisely, the third sealing ring groove is located between the external thread and the mounting flange. A hole diameter at a top of the base 1012 is the same as a hole diameter of the magnetic isolation sleeve 1011. A third sealing ring 7 is installed in the third sealing ring groove.

Further, a flange is provided on an outer side of an upper part of the valve body 11. The flange is provided with an external thread. The external thread of the flange matches an internal thread at a lower end of the first stepped hole inside the base 1012. At least one air outlet hole 15 axially runs through the flange. An air inlet hole 14 axially runs through a middle of the valve body 11.

Further, the first stepped hole includes a first through hole located outwardly and a second through hole close to an inner cavity, where a diameter of the second through hole is smaller than a diameter of the first through hole. A magnetic isolation groove 3051 is provided in a side wall of the armature 305 at a position near a lower part of the second through hole. In other words, the armature 305 has the magnetic isolation groove 3051 at a position aligned with a bottom of the stepped hole of the base 1012. The magnetic isolation groove 3051 is used to reduce a magnetic flux circulation area during an upward movement of the armature 305, thereby reducing a rising speed of electromagnetic force experienced by the armature 305 during the upward movement.

### Embodiment 7

On the basis of Embodiment 1, referring to FIGS. 1 and 2, a side wall at the bottom of the tightening cap 102 is a boss structure. Further, the boss structure is a conical boss structure. A groove for allowing the side wall at the bottom of the tightening cap 102 to enter and exit is provided on an outer side of the top of the armature 305. The boss structure is used to increase initial electromagnetic force, making the proportional valve more sensitive.

### Embodiment 8: (This Embodiment is a Variant Structure of Embodiment 7, Differing in a Position of the Boss Structure)

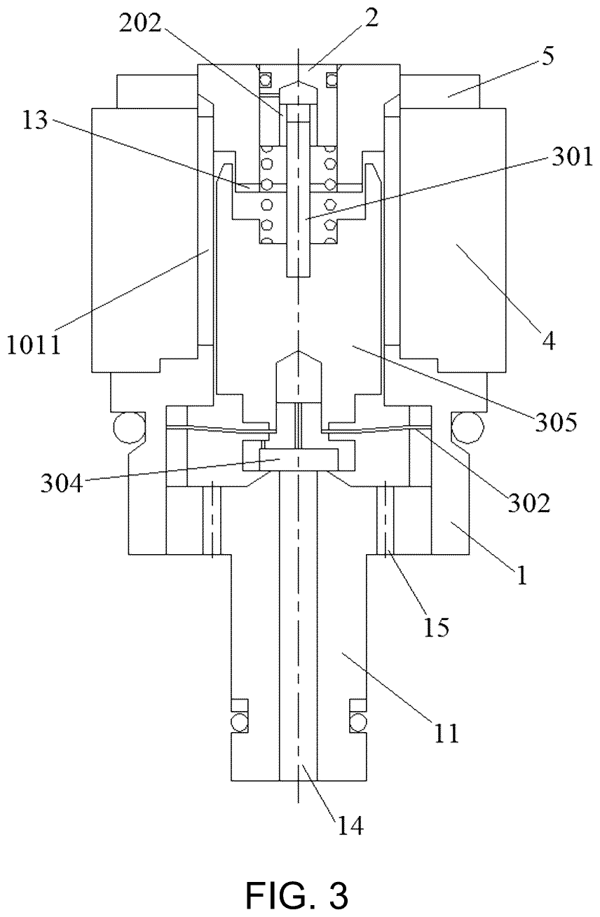

On the basis of Embodiment 1, referring to FIG. 3, a side wall of the top of the armature 305 is a boss structure. Further, the boss structure is a conical boss structure. A groove for allowing the side wall of the top of the armature 305 to enter and exit is provided on an outer side of the bottom of the tightening cap 102.

### Embodiment 9

On the basis of Embodiment 1, referring to FIGS. 1, 2, and 4, a magnetic isolation gasket 13 is installed at a bottom of the tightening cap 102 or at a top of the armature 305.

### Embodiment 10

On the basis of Embodiment 9, referring to FIGS. 1 and 2, a groove body is provided on an inner side of the bottom of the tightening cap 102. A magnetic isolation gasket 13 is installed in the groove body. The magnetic isolation gasket 13 is an annular structure made of a non-magnetically conductive material. Its outer diameter matches an installation groove of the tightening cap 102. An inner hole diameter is larger than an outer diameter of the armature spring 12. The top of the armature 305 is a boss structure adapted to the groove body at the bottom of the tightening cap 102 for allowing the boss structure at the top of the armature 305 to enter and exit the groove body at the bottom of the tightening cap 102. A diameter of the boss structure at the top of the armature 305 is smaller than an outer diameter of the armature and smaller than an inner diameter of a bottom of the through hole of the tightening cap 102.

Since electromagnetic force experienced by the armature 305 increases faster as the armature 305 and the tightening cap 102 approach each other, the magnetic isolation gasket 13 can prevent mismatch between electromagnetic force and spring force caused by the distance between the armature 305 and the tightening cap 102 being too close.

### Embodiment 11: (This Embodiment is a Variant Structure of Embodiment 10, Differing in an Installation Position of the Magnetic Isolation Gasket)

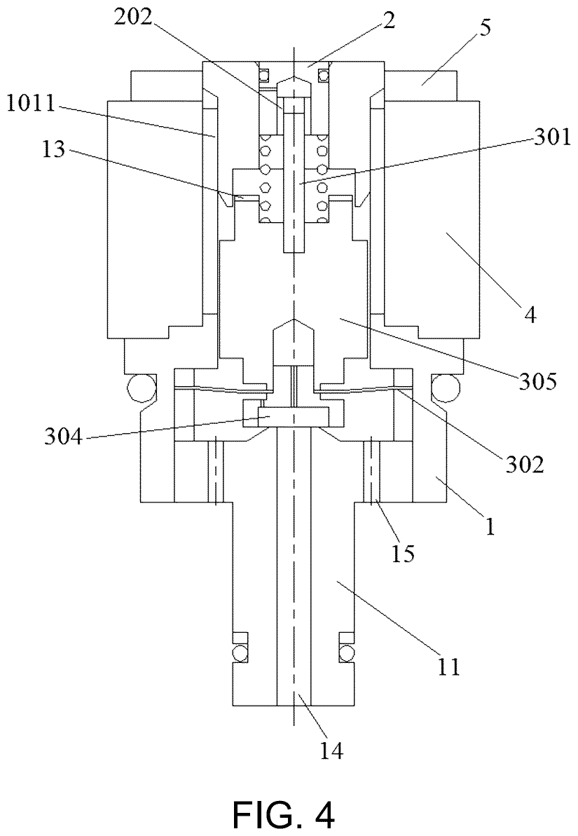

On the basis of Embodiment 9, referring to FIG. 4, a groove body is provided on an inner side of the bottom of the tightening cap 102. The top of the armature 305 is a boss structure adapted to the groove body at the bottom of the tightening cap 102. A magnetic isolation gasket 13 is installed on the boss structure at the top of the armature 305.

### Embodiment 12

On the basis of Embodiment 1, referring to FIGS. 1 and 2, a sealing gasket installation groove is provided at a bottom of the armature seat 303. A sealing gasket 304 is installed in the sealing gasket installation groove. A stepped hole serving as an air inlet hole 14 axially runs through a middle of the valve body 11. A hollow conical boss is provided at a top of the valve body 11. A diameter of the stepped hole on a side near the conical boss is smaller than a diameter of a top of the conical boss. A cone angle of the conical boss is 90°-120°. A hollow part of the conical boss communicates with the air inlet hole 14. The sealing gasket 304 is located above the hollow part of the conical boss. A width of an annular band formed by the top of the conical boss and a hole inside the conical boss is 0.2-0.5 mm.

During use, the sealing gasket 304 contacts the conical boss at the top of the valve body 11 to form a sealing surface.

Further, an exhaust hole enabling communication between an accommodating hole at the bottom of the armature 305 and the sealing gasket installation groove is provided at a top of the armature seat 303. A vent hole enabling communication between the first stepped hole inside the base 1012 and the sealing gasket installation groove is provided in the armature seat 303. The exhaust hole is used to allow gas inside to be discharged when the armature seat 303 is pressed into the armature 305. The vent hole is used to allow gas inside to be discharged when the sealing gasket 304 is pressed into the armature seat 303.

### Embodiment 13: (This Embodiment is a Variant Structure of Embodiment 12, Differing in an Installation Position of The Sealing Gasket)

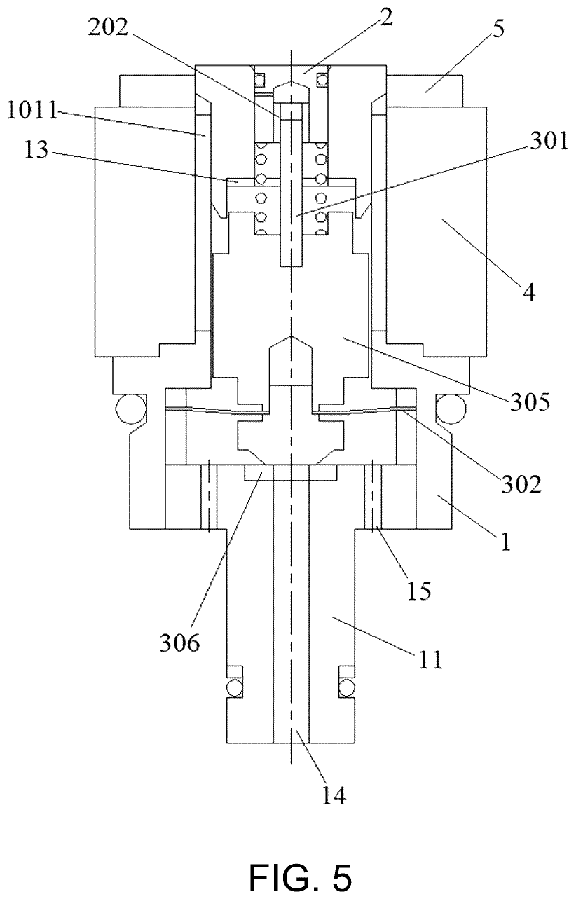

On the basis of Embodiment 1, referring to FIG. 5, an installation groove is provided at a top of the valve body 11. A hollow gasket 306 is installed in the installation groove. A protrusion structure adapted to a hollow part of the gasket 306 is provided at a bottom of the armature seat 303.

### Embodiment 14

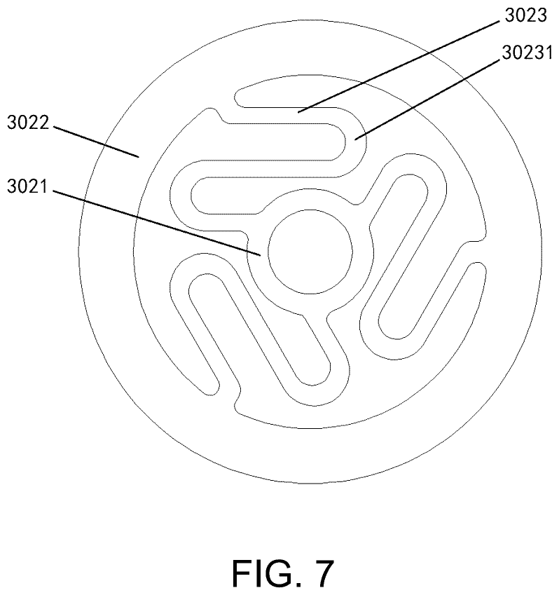

On the basis of Embodiment 1, referring to FIG. 7, the spring piece 302 includes a first ring 3021 and a second ring 3022. A diameter of the first ring 3021 is smaller than a diameter of the second ring 3022. The first ring 3021 and the second ring 3022 are connected together by at least three reciprocating bending structures 3023. Each of at least three reciprocating bending structures 3023 includes a bent section 30231. A width of the bent section 30231 is greater than a width of another part of the reciprocating bending structure 3023.

### Embodiment 15

On the basis of Embodiment 1, referring to FIGS. 1, 2, and 8, a valve body gasket 10 is installed between the spring piece 302 and the valve body 11 to thereby press the spring piece 302.

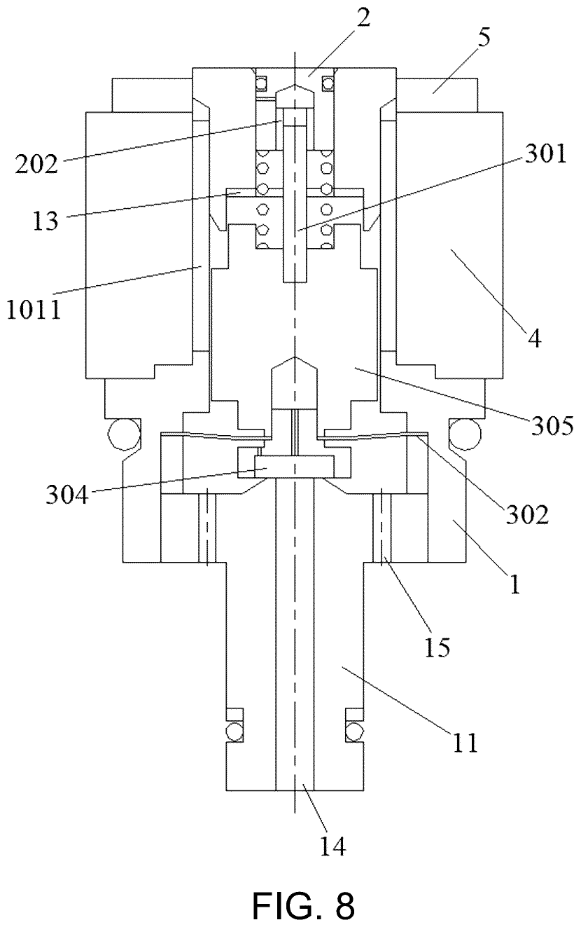

The spring piece 302, after being tightly pressed, is bowl-shaped with periphery upward and center downward. Certainly, the valve body gasket 10 can also be replaced by adding a corresponding structure on the valve body 11. FIG. 2 is a schematic structural diagram after removal of the valve body gasket 10 based on Embodiment 1. A lift adjustment gasket 9 is installed between the spring piece 302 and an inner top wall of the base 1012. Specifically, the lift adjustment gasket 9 and the valve body gasket 10 are both annular structures. Outer diameters of the lift adjustment gasket 9 and the valve body gasket 10 match a thread bottom hole diameter at a lower part of the base 1012. Inner diameters of the lift adjustment gasket 9 and the valve body gasket 10 are larger than an inner diameter of an outer annular portion of the spring piece 302. The thickness of the lift adjustment gasket 9 can be selected from various specifications. With the use of lift adjustment gaskets 9 of different thicknesses, a distance between a boss of the armature 305 and a magnetic isolation gasket 13 installed on an inner side of a bottom of the tightening cap 102 can be adjusted. Certainly, the lift adjustment gasket 9 can also be replaced by adding a step on the base 1012. FIG. 8 is a schematic structural diagram after removal of the lift adjustment gasket 9 based on Embodiment 1.

Working principle:
When the proportional valve is de-energized, the sealing gasket 304 at the bottom of the armature assembly 3 is tightly pressed by the armature spring 12 to come into contact with a boss at the top of the valve body 11 to form a sealing surface. There is no gas flow between the air inlet hole 14 and the air outlet hole 15.

When the proportional valve is energized, the armature assembly 3 moves upward under electromagnetic force, overcoming a spring force of the armature spring 12. The sealing surface is opened, and gas flows from the air inlet hole 14 to the air outlet hole 15.

Obviously, the above embodiments of the present invention are merely examples for clearly illustrating the present invention and are not limitations to the embodiments of the present invention. For those of ordinary skill in the art, other changes or variations in different forms can be made based on the above description. It is neither necessary nor possible to exhaustively list all embodiments here. Any modifications, equivalent replacements, improvements, and the like made within the spirit and principles of the present invention should be included in the protection scope of the claims of the present invention.

What is claimed is:

1. A proportional valve, comprising:
a welded body component comprising a welded component and a tightening cap connected to the welded component, wherein the welded component comprises a magnetic isolation sleeve and a base connected to the magnetic isolation sleeve, and a valve body is disposed at a lower part of the base;
an armature assembly comprising a spring piece, an armature seat, and an armature mechanism, wherein the armature seat is installed at a bottom of the armature mechanism and tightly presses the spring piece between the armature mechanism and the armature seat, an armature spring is sleeved on an outer side of an upper part of the armature mechanism, a guide mechanism for guiding a moving direction of the armature mechanism is installed inside the tightening cap, a bottom of the guide mechanism is configured as a hollow structure, and an upper part of the armature mechanism is located in the hollow structure at the bottom of the guide mechanism; and
a coil assembly (4) sleeved on an outer side of the magnetic isolation sleeve.

2. The proportional valve according to claim 1, wherein a valve body gasket is installed between the spring piece and the valve body, and a lift adjustment gasket is installed between the spring piece and an inner top wall of the base.

3. The proportional valve according to claim 1, wherein the armature mechanism comprises a shaft and an armature, a second stepped hole is provided at a top of the armature, a lower end of the shaft is located in the second stepped hole, a spring guide hole is formed between an inner wall at an upper end of the second stepped hole and an outer wall of the shaft, the armature spring is sleeved on an outer side of the armature, and a lower end of the armature spring is disposed in the spring guide hole.

4. The proportional valve according to claim 1, wherein the guide mechanism is an adjustment screw assembly, the adjustment screw assembly comprises an adjustment screw, a through hole is provided inside the tightening cap, the adjustment screw is threadedly connected to an inner wall of the tightening cap, a bottom of the adjustment screw is a hollow structure, the armature mechanism comprises a shaft and an armature, and a second stepped hole is provided at a top of the armature.

5. The proportional valve according to claim 4, wherein a bearing installation groove is provided in an inner wall at the bottom of the adjustment screw, a bearing is installed in the bearing installation groove, an upper end of the shaft is installed inside the bearing, and a lower end of the shaft is press-fitted into the second stepped hole at the top of the armature.

6. The proportional valve according to claim 4, wherein a bearing is installed in the second stepped hole at the top of the armature, a lower end of the shaft is installed inside the bearing, and an upper end of the shaft is press-fitted into the hollow structure at the bottom of the adjustment screw.

7. The proportional valve according to claim 1, wherein a boss is provided at a top of the base, a bottom of the coil assembly is in contact with the boss, and a hex thin nut is threadedly connected to an outer side wall of the tightening cap above the coil assembly.

8. The proportional valve according to claim 1, wherein a flange is provided on an outer side of an upper part of the valve body, the flange is provided with an external thread, a first stepped hole is provided inside the base, the valve body is installed inside the first stepped hole, the external thread of the flange matches an internal thread at a lower end of the first stepped hole in the base, at least one air outlet hole axially runs through the flange, and an air inlet hole axially runs through a middle of the valve body.

9. The proportional valve according to claim 1, wherein an external thread is provided on a side wall of a lower end of the base, a first stepped hole is provided inside the base, the first stepped hole comprises a first through hole located outwardly and a second through hole close to an inner cavity, a diameter of the second through hole is smaller than a diameter of the first through hole, the armature mechanism comprises a shaft and an armature, and a magnetic isolation groove is provided in a side wall of the armature at a position near a lower part of the second through hole.

10. The proportional valve according to claim 1, wherein a side wall at a bottom of the tightening cap is a boss structure, the armature mechanism comprises a shaft and an armature, and a groove for allowing the side wall at the bottom of the tightening cap to enter and exit is provided on an outer side of a top of the armature.

11. The proportional valve according to claim 1, wherein the armature mechanism comprises a shaft and an armature, a side wall of a top of the armature is a boss structure, and a groove for allowing the side wall of the top of the armature to enter and exit is provided on an outer side of a bottom of the tightening cap.

12. The proportional valve according to claim 1, wherein the armature mechanism comprises a shaft and an armature, and a magnetic isolation gasket is installed at a bottom of the tightening cap or at a top of the armature.

13. The proportional valve according to claim 1, wherein a sealing gasket installation groove is provided at a bottom of the armature seat, a sealing gasket is installed in the sealing gasket installation groove, an air inlet hole axially runs through a middle of the valve body, a hollow conical boss is provided at a top of the valve body, a hollow part of the conical boss communicates with the air inlet hole, and the sealing gasket is located above the hollow part of the conical boss.

14. The proportional valve according to claim 1, wherein an installation groove is provided at a top of the valve body, a hollow gasket is installed in the installation groove, and a protrusion structure adapted to a hollow part of the gasket is provided at a bottom of the armature seat.

15. The proportional valve according to claim 1, wherein the spring piece comprises a first ring and a second ring, a diameter of the first ring is smaller than a diameter of the second ring, the first ring and the second ring are connected together by at least three reciprocating bending structures, each of the at least reciprocating bending structures comprises a bent section, and a width of the bent section is greater than a width of another part of the reciprocating bending structure.
